(19) United States
(12) Patent Application Publication
(10) Pub. No.: US 2006/0239173 A1
(43) Pub. Date: Oct. 26, 2006

(54) Optical storage with direct digital optical detection

(76) Inventors: Yi Zhang, San Diego, CA (US); Sadik C. Esener, Solana Beach, CA (US)

Correspondence Address: FISH & RICHARDSON, PC, P.O. BOX 1022, MINNEAPOLIS, MN, 55440-1022, US

(21) Appl. No.: 11/405,982

(22) Filed: Apr. 17, 2006

Related U.S. Application Data
(60) Provisional application No. 60/674,966, filed on Apr. 25, 2005.

(51) Int. Cl. G11B 7/00

(52) U.S. Cl. 369/124.12

(57) ABSTRACT

Optical data storage devices and techniques that use digital optical detection to obtain digital signals from light returned from optical storage media without analog processing and analog to digital conversion.

This application claims the benefit of U.S. Provisional Application No. 60/674,966 entitled “OPTICAL STORAGE WITH DIRECT DIGITAL OPTICAL DETECTION” and filed Apr. 25, 2005, the entire disclosure of which is incorporated by reference as part of the specification of this application.

### BACKGROUND

This application relates to optical disk drives and the optical detection and processing of optical output from optical disks.

Optical disk drives can be configured in various configurations. Some examples include audio compact disk (CD) players, computer CD-ROM drives, DVD players, Blu-Ray DVD players and HD-DVD players, and others. Optical disk drives have been widely used in a wide range of application where digital data storage is used, including but not limited to home video, audio and computer data storage, etc.

Many optical disk drives implement an optical pick-up unit (OPU) which uses a laser diode to produce an input beam and an optical detector such as a photodiode to detect reflected light from the optical disk. The optical detector converts the reflected light into an analog electronic signal. An analog-to-digital conversion circuit is used to convert the analog signal into digital bits for extracting data. FIG. 1A illustrates one example of an optical pick-up unit widely used in various optical disk drives. A laser diode (LD) 1 is used to produce a linearly polarized laser beam which is collimated by a collimation lens module 2. The collimated beam transmits through a polarization beam splitter (PBS) 3 and a quarter wave plate 4 and is focused on the information layer of an optical disk 6 by an objective lens 5. The reflected beam from the optical disk 6 is reflected back to the objective lens 5 and is then collimated again. After passing through the quarter wave plate 4, the polarization direction of the reflected beam is rotated by 90 degrees comparing to the original incoming beam to the disk 6. As such, the reflected beam is reflected by the PBS 3 to a different optical path leading to a photodiode 8. A lens 7 is placed between the PBS 3 and the photodiode 8 to focus the reflected beam.

FIG. 1B shows an example of the optical-to-data signal train and the associated data readout circuitry used in various optical disk drives. The data readout circuitry includes an analog processing circuit, an analog-to-digital converter (A/D), and a digital processing part. Analogue signal processing may include one or more of the following circuit: an amplifier, a signal filter, an equalization circuit, etc. to process the analog signal from the photodiode. After the conversion into digital bits, the signal is digitally processed and decoded to extract the digital data.

Optical disk drives typically implement a servo control to process the analog output of the photodiode to obtain errors in the beam focusing and the beam positioning and use a feedback control in response to the errors to control the operation of the optical pick-up unit for proper optical focusing and beam positioning on the disk. The servo control is an analog circuit in many optical disk drives. FIG. 1C illustrates one example of the data readout circuitry with analog processing and analog to digital conversion. The analog processing circuit in the illustrated implementation includes preamplifier, an automatic gain control (AGC) circuit, a low pass filter (LPF) and a signal equalizer he analog servo control circuitry used in many optical disk drives. The analog servo control circuit includes a preamplifier, a LPF, a servo error detection circuit to detect the error to produce a servo drive signal that is fed back to control the optical pickup unit.

### SUMMARY

This application provides implementations of optical data storage devices and techniques that use digital optical detection to obtain digital signals from light returned from optical storage media without analog processing and analog to digital conversion.

In one method, for example, the light reflected from an optical storage medium is directly converted into electronic digital pulses without analog processing and analog to digital conversion. Next, the electronic digital pulses are digitally processed to obtain information carried in the light reflected from the optical storage medium. The extracted information may be the data encoded in optical storage medium or servo control information such as the focusing error and the tracking error in optical disk drives. The optical storage medium may be an optical disk such as an audio compact disk (CD), a computer CD-ROM, a DVD, a Blu-Ray DVD and a HD-DVD. As another example, the optical storage medium may be an optical disk that records data bits in a volume by two-photon optical absorption. In some implementations of the above method, an input light beam incident to the optical storage medium may be modulated at a modulation frequency and the digital electronic pulses may be sampled at the modulation frequency in extracting the information in the returned optical beam to suppress noise.

One example of an optical data storage device described in this application includes an optical pickup unit to direct an input optical beam to an optical storage medium and to receive a returned optical beam from the optical storage medium in response to the input optical beam, an optical sensor comprising a digital photodetector positioned to receive the returned optical beam from the optical pickup unit and to directly convert received light into digital electronic pulses; and a digital processing circuit coupled to directly receive the digital electronic pulses from the optical sensor and configured to digitally process the digital electronic pulses to extract information in the returned optical beam.

Another example of an optical data storage device described in this application includes an optical pickup unit, an optical sensor comprising an array of digital photodetectors, a digital data processing circuit and a digital servo control circuit. The optical pickup unit is used to direct an input optical beam to an optical storage medium and to receive a returned optical beam from the optical storage medium in response to the input optical beam. The array of digital photodetectors is positioned to receive the returned optical beam from the optical pickup unit and the digital photodetectors directly convert received light into a plurality of trains of digital electronic pulses without analog to digital conversion, respectively. Different trains of digital electronic pulses correspond to light received at different locations within the returned optical beam at the optical sensor. The digital data processing circuit is coupled to directly receive the digital electronic pulses from the optical sensor and configured to digitally process the digital electronic pulses to extract data in the returned optical beam. The digital servo control circuit directly receives the digital electronic pulses from the optical sensor and configured to digitally process the trains of digital electronic pulses of the different digital photodetectors to produce a digital focusing error signal and a digital tracking error signal.

This application also describes an optical storage medium having pit and land features to represent digital data bits where all pit features have an equal dimension according to a pulse position modulation (PPM) data code. In some implementations, such an optical storage medium may be an optical disk and an optical disk drive for such a disk may use the present digital optical detection or the conventional analog optical detection with analog processing and analog to digital conversion.

These and other implementations and features and their operations are described in greater detail in the attached drawings, the detailed textual description, and the claims.

### BRIEF DESCRIPTION OF DRAWINGS

FIG. 1A illustrates one example of an optical pick-up unit widely used in various optical disk drives.

FIG. 1B shows an example of the optical-to-data signal train and the associated data readout circuitry used in many optical disk drives.

FIG. 1C illustrates one example of the data readout circuitry (with analog processing and analog to digital conversion) and the analog servo control circuitry used in many optical disk drives.

FIG. 2 shows a block diagram of the digital optical detection and direct digital processing of the digital output from the optical detection without analog processing and analog to digital conversion.

FIG. 3A shows an example of an optical disk with track pit and land features according the pulse width modulation used in many optical disk drives.

FIG. 3B shows characteristics of analog output of an analog photodetector when detecting a reflected beam from an optical disk in an optical disk drive.

FIGS. 4A and 4B show the circuit layout and the structure of a Geiger mode single photon avalanche photodiode as an example of various photodiodes that may be used for direct digital optical detection in optical storage systems described in this application.

FIG. 4C shows an exemplary response of one implementation of the Geiger mode single photon avalanche photodiode shown in FIGS. 4A and 4B.

FIG. 4D shows an exemplary photodiode array wherein each photodiode is a Geiger mode single photon avalanche photodiode shown in FIGS. 4A and 4B.

FIG. 5 illustrates operation of a Geiger mode single photon avalanche photodiode shown in FIGS. 4A and 4B when detecting reflected light from a particular optical disk having data features based on a pulse width modulation, where a corresponding analog output from an analog photodiode for the same reflected light is also shown for comparison.

FIGS. 6 and 7 illustrate an example of a pulse position modulation for data coding on optical disks and associated analog and digital signals from an analog photodiode and a digital photodiode.

FIGS. 8A and 8B show examples of data features in optical disks and the associated beam spatial profiles in the reflected light.

FIG. 8C shows a use of different regions within a digital photodiode array for a differential data readout according to one implementation of the digital optical detection and direct digital processing.

FIG. 9 shows an exemplary circuit block diagram of a digital photodiode array and the corresponding digital data extraction circuit.

FIG. 10 shows an example of a digital servo control based on a digital photodiode array for direct digital optical detection and direct digital processing.

FIG. 11 illustrates an example of an optical disk drive that implements a digital photodetector array in the optical pickup unit, a digital processing circuit for data readout and a digital servo control circuit.

FIG. 12 shows one example of a system-on-chip design of the data readout and servo control for an optical disk drive where the digital photodetector array, the digital servo circuit and the digital data retrieval circuit are monolithically integrated on a single chip.

FIGS. 13A and 13B show an example of an optical disk drive using a modulation signal to modulate the input beam to the optical disk and the digital optical detection.

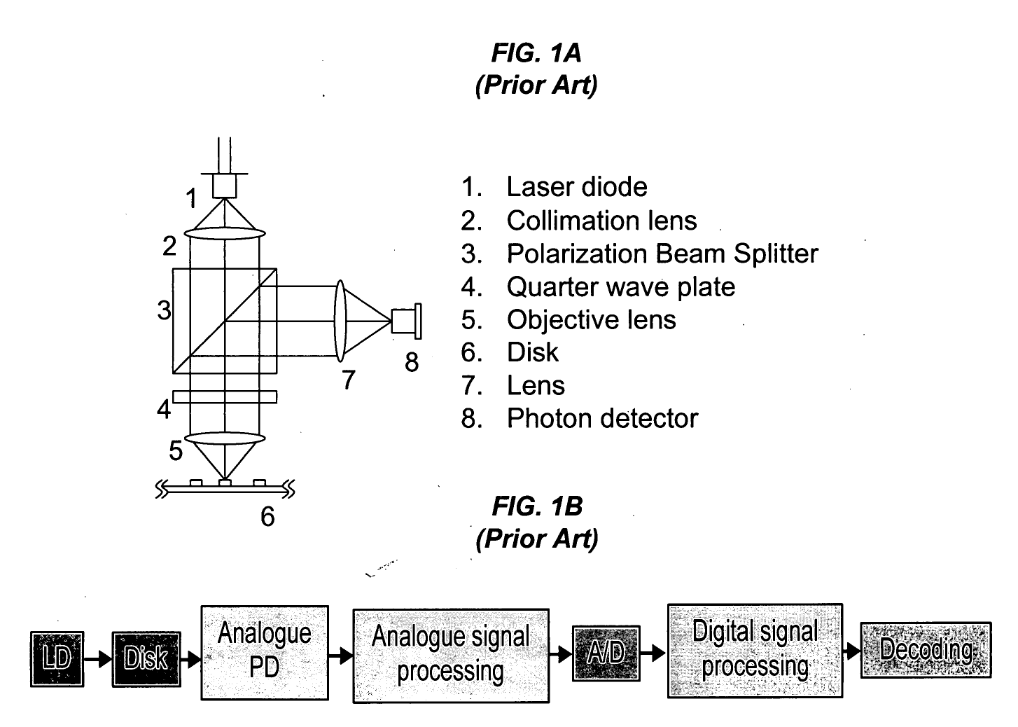

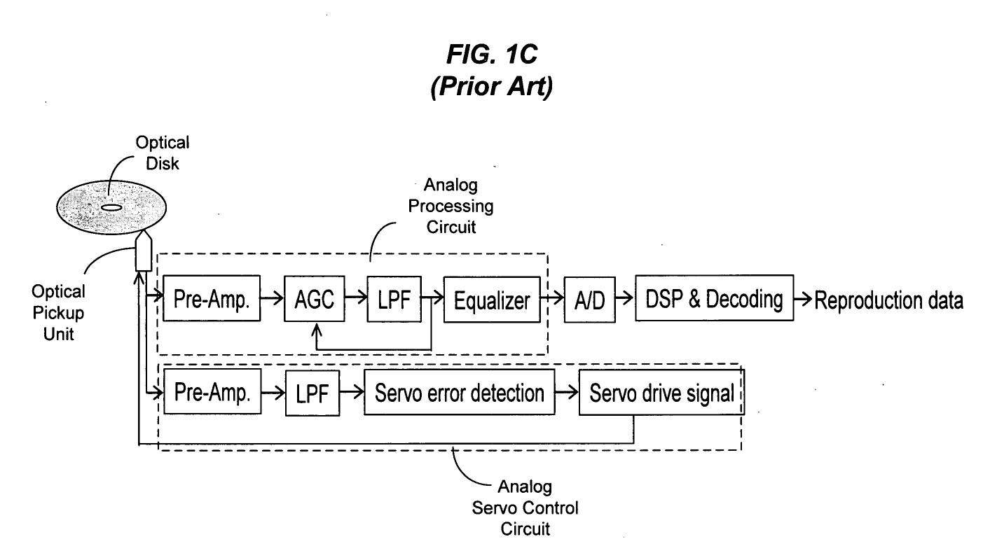

### DETAILED DESCRIPTION

This application describes, among others, optical digital detection of light from optical storage media in optical storage systems and associated digital readout circuitry and digital servo control. The designs and techniques for digital optical detection and digital processing may be applied to optical disk drives and other optical data storage systems using optical storage media different from optical disks.

The specific examples described in this application use optical disk drives, including high-capacity optical disk drives that use blue laser light, to illustrate various features. A highly sensitive digital photodetector is implemented to directly convert the light beam from the optical disk into an electronic digital signal and hence digital processing may be directly used to extract the data without analog processing and analog-to-digital conversion. This design can be used to eliminate the analog processing circuit and the analog-to-digital converter in the data readout circuitry and thus significantly reduce the signal noise and distortions associated with the analog processing and analog-to-digital conversion. This design can also simplify the circuit design of the optical detection and the readout circuitry and reduce the device cost and improve the device reliability. Analog processing circuits and digital processing circuits are difficult to integrate on a single chip. The present design without the analog processing allows for integration of the digital readout circuit with the digital optical detector on a single chip via the standard CMOS processing. In addition, the high sensitivity of the digital photodetector allows the minimum operating power of the input beam to be reduced significantly in comparison with optical disk drives with analog optical detection. Furthermore, the power efficiency of the readout circuit can be improved over optical readout designs that use analog processing and analog-to-digital conversion.

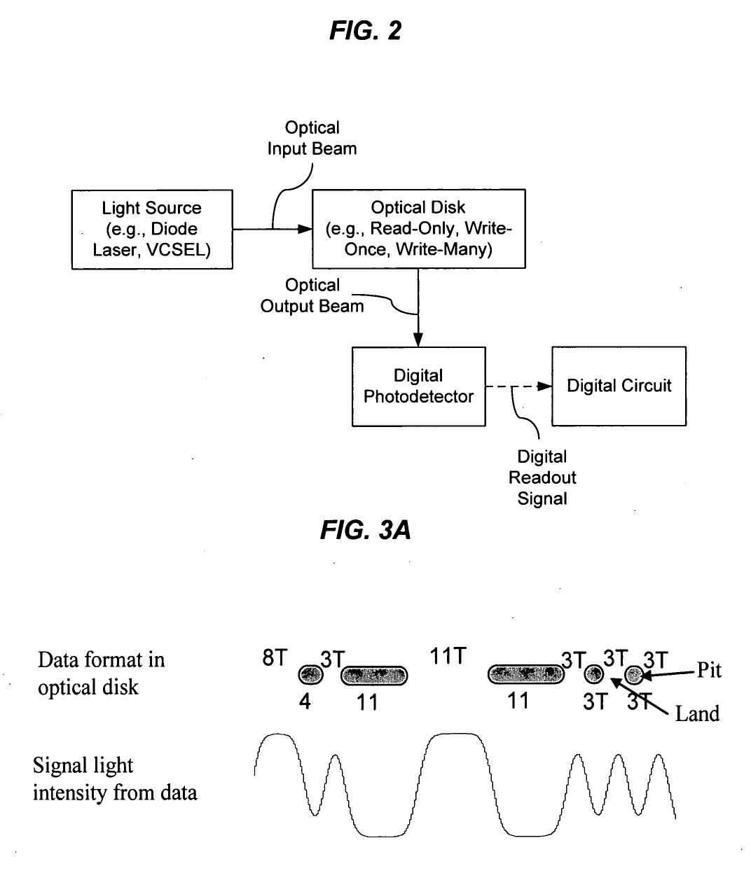

FIG. 2 shows a block diagram of one example of an optical disk drive that uses the present direct digital optical detection and digital processing without analog processing and analog-to-digital conversion. A low-power light source, such as a semiconductor laser, is used to produce the optical input beam to the optical disk. A semiconductor edge-emitting diode laser or a semiconductor vertical cavity surface emitting laser (VCSEL) may be used as the light source. The optical disk may be any suitable optical disk. The optical reflection from the optical disk is directed to a digital photodetector which directly outputs digital readout signal to a digital circuit for further digital processing. This design provides a complete digital readout solution for optical disk drives. The system may be configured in a compact package. A standard COMS processing could be applied to the design and fabrication of the digital photodiode, the readout system could be low cost and low power consumption. With a proper design, digital photodiode, digital signal processing and decoding function could be integrated in one Application-Specific Integrated Circuits (ASIC). A System-on-Chip (SoC) system could be realized based on the ASIC. Another benefit is that this digital photodiode can be highly sensitive and thus a low laser power can be used to readout disk information.

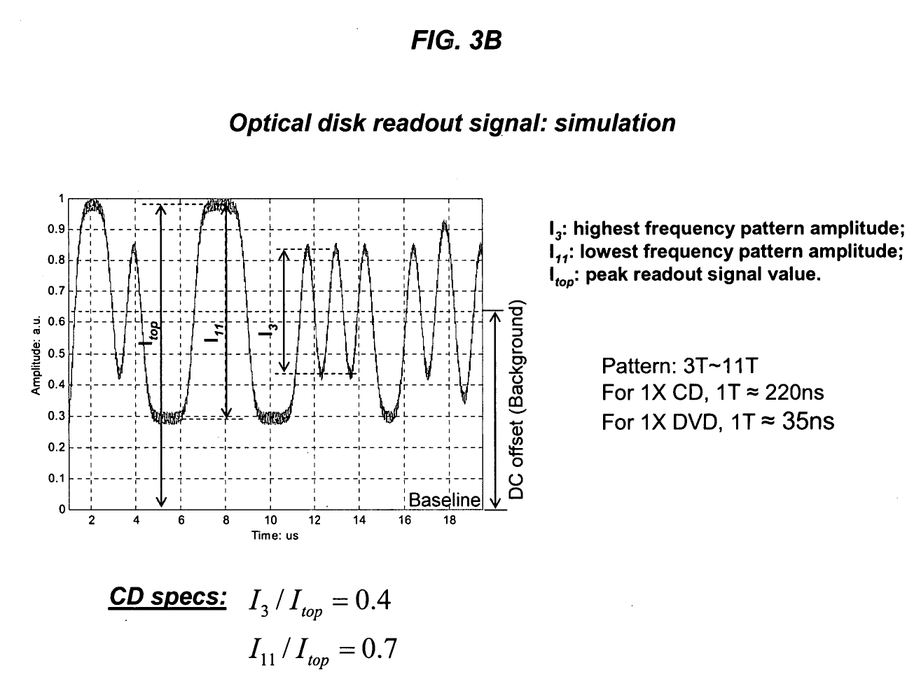

FIG. 3A illustrates an example of physical features in a track on an optical disk and corresponding analog optical signal intensity of the reflected optical beam from the optical disk. In this example, data is stored in the optical disk as “pit” and “land” features based on the pulse width modulation (PWM). A land feature may be highly reflective to produce a high reflection and a pit feature may be less reflective and thus produce a low reflection. The length of each feature along the track direction is used for the PWM for encoding the data. As the input laser beam moves over the pits and lands in a track on the disk, the intensity of the reflected beam is modulated to carry the data and the servo information. In one implementation of the PWM, the length of a “pit” or a “land” is nT, where n is an integer (3, 4, . . . 11, etc) and T is the clock period. During the readout, the input laser beam is focused on the information layer. The optical analog readout signal is the convolution between point spread function of the input laser beam and the “pit” and “land.”

The intersymbol interference (ISI) between signals from adjacent features on the disk can cause the signal amplitudes of different frequency patterns to vary and thus to be different. The amplitude of a higher frequency pattern (such as the pattern with a length of 3T) can be less than the amplitude of a lower frequency pattern (such as the pattern with a length of 11T). Due to the background signal, some DC offset could be applied to the readout signal. FIG. 3B shows a typical readout high-frequency (HF) signal from a CD-ROM. Some CD-ROM systems impose certain requirements for the HF signal, such as I11/Itop>0.6 and I3/Itop is between 0.3˜0.7, where Itop is the maximum HF output signal, I11 is the amplitude of 11T pattern and I3 is the amplitude of 3T pattern. Some analogue noises (such as the optical noise, detector noise and electrical noise, etc) are added to the HF signal. For at least these reasons, the optical analog detection is inherently noisy.

The optical digital detection in FIG. 2 can be used to eliminate the various noise sources in analog optical detection. The digital photodetector in FIG. 2 may be implemented in various configurations. For example, Geiger-mode avalanche photodiodes for single-photon detection may be used. The digital photodetector directly outputs an electronic digital signal in response to the analog optical input.

A wide range of Geiger-mode avalanche photodiodes for single-photon detection have been developed for applications other than optical storage systems. Certain Geiger-mode avalanche photodiodes are commercially available from various manufactures, including PerkingElmer and id Quantique. Some exemplary designs are described in U.S. patent application Nos. 20040106265 entitled “Avalanche photodiode for photon counting applications and method thereof,” 20010020863 entitled “Circuit for high precision detection of the time of arrival of photons falling on single photon avalanche diodes,” 20050051858 entitled “Near-infrared visible light photon counter,” 20050029434 entitled “Method for manufacturing photodetector for weak light,” 20050023542 entitled “Photodetector for weak light having charge reset means,” and 20050012033 entitled “Digital photon-counting geiger-mode avalanche photodiode solid-state monolithic intensity imaging focal-plane with scalable readout circuitry.” Also see, e.g., U.S. Pat. No. 6,720,588 entitled “Avalanche photodiode for photon counting applications and method thereof.” These and other Geiger-mode avalanche photodiodes may be adopted for optical storage systems described in this application.

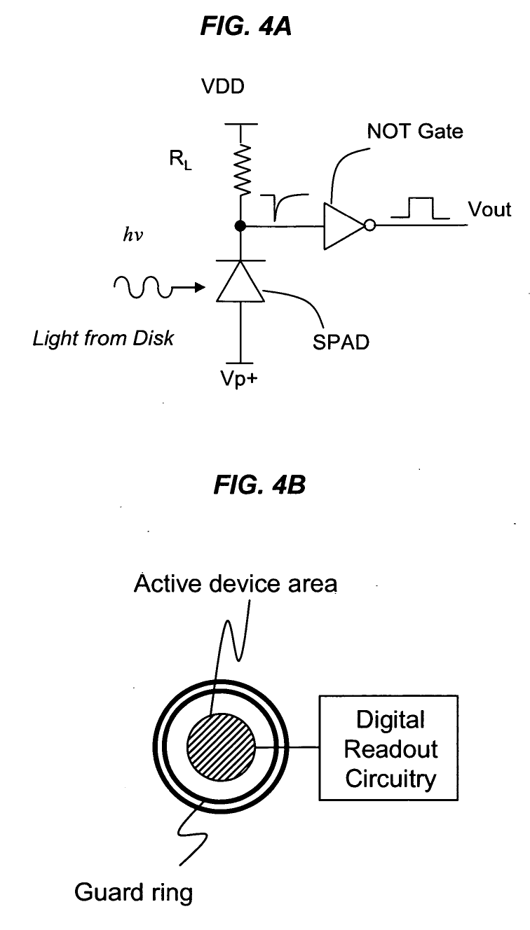

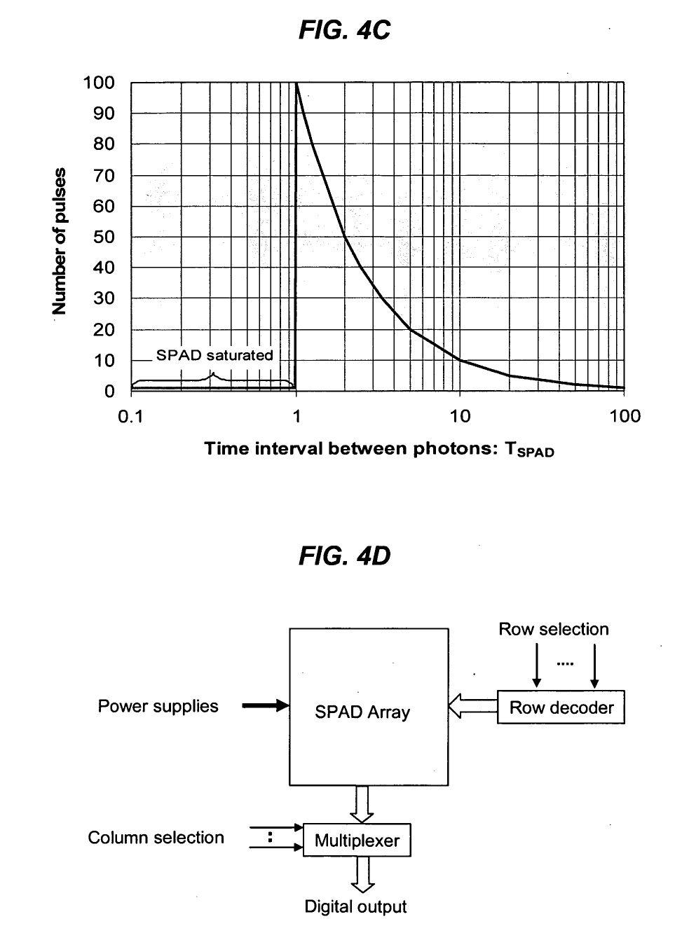

One example of such a Geiger-mode avalanche photodiode is the Single Photon Avalanche Diode (SPAD) designed by Prof. Edoardo Charbon and his group at the Ecole Polytechnique Fédérale de Lausanne (EPFL), Switzerland for 3-dimensional imaging applications. See, Niclass et al., “A CMOS 3D Camera with Millimetric Depth Resolution” (C. Niclass, A. Rochas, P. A. Besse, E. Charbon, IEEE Custom Integrated Circuits Conference (CICC), pp. 705-708, October 2004.) which is incorporated by reference as part of the specification of this application. FIGS. 4A, 4B, 4C and 4D show various features of SPAD.

FIG. 4A shows an example of the circuit structure of the SPAD with an integrated output circuit. The SPAD is electrically bias via a load resistor RL between potentials V_{DD} and V_{P+}. A logic NOT gate is used as an inverter to convert each digital output pulse of the SPAD into a conditioned digital pulse for further processing by subsequent digital circuitry for the data readout and for the digital servo control processing. FIG. 4B shows an example of the schematic layout of the SPAD which includes a central photosensitive active device area and a conductive guard ring to electrically isolate the active area from its surroundings and to reduce its parasitic capacitances. This SPAD operates as follows. If there is no input photon received by the SPAD, the output of SPAD is low, corresponding to a digital level of 0. When a photon arrives on the detector, the breakdown current discharges the depletion region capacitance. As a result, the voltage across the SPAD is reduced to its breakdown voltage. The output of the inverter circuit goes to a high level. After avalanche quenching, the SPAD is recharged through the load resistor (R_{L}) and is ready for receiving and detecting the next photon and the output of the inverter comes back to low. The recharging time of the SPAD is called a “dead time” because the SPAD is not responsive to any received photon during this period. More specifically, if another photon comes before the SPAD is recharged, the SPAD is kept in its breakdown voltage and the inverter output keeps high, that is, the SPAD is saturated. With this structure, the SPAD can detect single photon and send out a corresponding digital pulse output. If another photon is coming after the recharging time, another pulse is generated.

The SPAD shown in FIGS. 4A and 4B is a highly sensitive photon density detector. FIG. 4C shows the number of the SPAD output pulses for different photon numbers with a certain observation time when photons arrive at the SPAD equally in time. The dead time of SPAD is denoted by “T_{SPAD}.” When the time interval of photons arriving is shorter than the SPAD dead time T_{SPAD}, the SPAD is saturated and the output keeps high. With the increasing of the time interval of incoming photons, the number of output pulses decreases within the observation time.

When this SPAD is used for optical disk readout, the dead time T_{SPAD} of the SPAD should be smaller than the period of the highest frequency signal in the output optical beam from the optical disk. Under the Nyquist's sampling theorem, for lossless digitization, the minimum sampling rate should be at least twice of the maximum frequency of a signal under sampling. In many optical data storage systems, the higher frequency signal is the 3T pattern, i.e., the RLL(3,11) modulation. The maximum signal frequency of the 3T pattern is ⅙T, therefore, minimum sampling frequency should be ⅓T. Hence, when the SPAD is used to detect the optical signal from the disk, the SPAD effectively operates as a digital sampling module and the dead time of the SPAD should be smaller than 3T. This sets an upper limit for the dead time. For a better signal quality, a shorter dead time than this maximum value is preferred. The dead time of the current SPADs from Prof. Charbon's group is about 25 ns and can be reduced to about 2 ns with certain modifications to the designs. When the SPAD is used in the optical disk drive, the laser power can be adjusted to be sufficiently low to directly obtain a digital readout signal from the optical output of the optical disk.

The SPAD shown in FIGS. 4A and 4B is a single sensor detector. The SPAD may also be configured as a sensor array with multiple SPAD sensors. FIG. 4D illustrates a SPAD array with column and row selection circuits as described in the aforementioned publication by Niclass et al. Such a SPDA array as a whole may be used as the digital photodetector for the optical disk drive in FIG. 2.

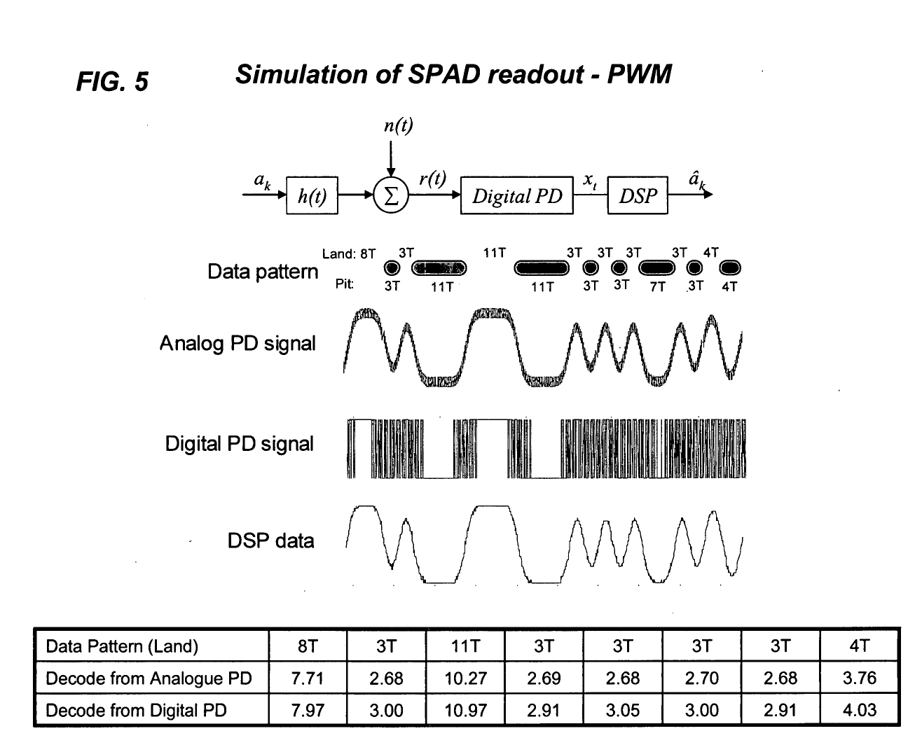

FIG. 5 further illustrates the operation of the SPAD as the digital photodetector for an optical disk drive. During the optical disk readout, the input laser beam scans different land or pit patterns recorded in the optical disk. When the beam scans 11T land pattern, which is the low frequency pattern, the light intensity reflected from the optical disk is the maximum and the SPAD outputs a high output and can be saturated by the incoming light. See., e.g., the signal corresponding to the land feature 11T(L) in FIG. 5. When the beam scans the 11T pit pattern, the light intensity reflected from optical disk at the minimum. Under this condition, because very little photons come back to the SPAD, a less number of pulses or even no pulse is generated by the SPAD. The signals for the 11T(P) feature illustrate this situation. For the highest frequency signal component in the optical output from the optical disk (such as the 3T pattern), the reflected light intensity is between the maximum and the minimum values and the SPAD may not be saturated. Accordingly, there is always some pulses output from the SPAD. For the 3T land (3T(L)), more photons could be detected by the SPAD than the photons from the 3T pit (3T(P)) pattern and therefore more pulses are generated. For a certain time, the pulse density of 3T(L) is higher than that of 3T(P). In this regard, the function of SPAD is similar to a 1-bit analog-to-digital converter (ADC).

If the digital signal processing (DSP) is applied to the pulse density signal from the SPAD, the data pattern from optical disk can be directly retrieved. The top block diagram in FIG. 5 further shows a signal model for the data detection and signal processing of the digital PD. During readout, the data pattern aₖ stored in the optical disk is a convolution with the readout system transfer function h(t). Some noise n(t) is added to the signal during the readout. The digital PD continuously sends out a 1-bit signal xt. With an n-bit digital counter, the 1-bit xt is converted to n-bit data. If it's necessary, other DSP functions (such as digital filter, equalization, etc.) may be applied to the n-bit DSP data stream. The readout data pattern âk may be decoded from the n-bit DSP data.

As a comparison, FIG. 5 shows both analog output form an analog photodiode and the digital output from the digital SPAD from the same data pattern on the optical disk. The analogue photodiode generates a continuous analogue signal. With further analogue signal processing and DSP, we can get the data pattern shown in the Table in the bottom of FIG. 5. Digital PD sends out digital signal directly. With proper DSP such as a digital counter, the readout data pattern can be obtained. The Table in FIG. 5 compares the decoding pattern from analogue PD and digital PD where a 24 bit counter is applied to the digital PD. The result in Table in FIG. 5 suggests that the digital PD with DSP can retrieve data pattern accurately.

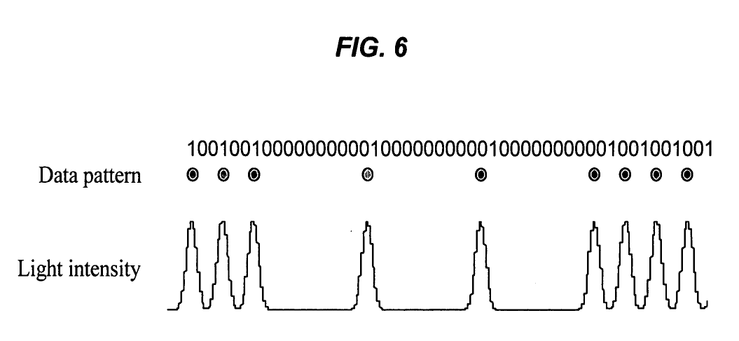

In the above example, the data is encoded via the pulse width modulation on the optical disk where the length of each feature along the track direction is used for encoding the data. Alternatively, a Pulse Position Modulation (PPM) may also be used. In one implementation of this PPM, every recorded dot position on the optical disk has the same dimension along the track direction and represents one bit. Different from PWM, the length of a pattern is not used to represent data in the present PPM. The contrast between a bit “1” and a bit “0” in PPM-coded patterns is sufficiently good. FIG. 6 shows the output light intensity from a PPM optical disk detected by an analog optical detector.

Notably, the PPM encoding can be used in combination with the present digital optical detection as illustrated in FIG. 2. The digital photodetector can directly convert the PPM patterns on the disk into one-bit digital data readout signal.

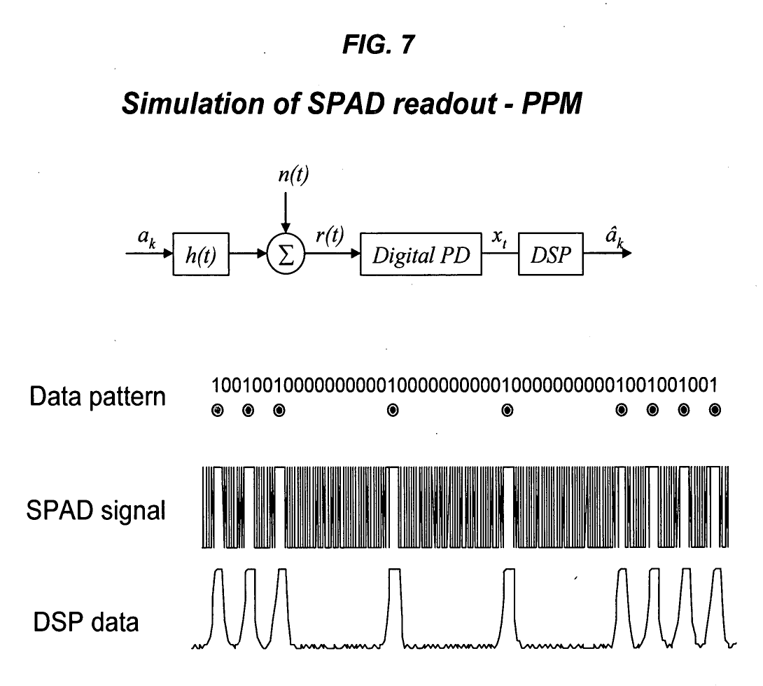

FIG. 7 shows examples of the PPM data pattern and typical readout signal with a digital PD such as the SPAD. The readout PPM data pattern with the digital PD can be simple and straight forward. Because of the noise, the digital PD produces output pulses even when the incident photon is caused by noise from scattered light. However, in the PPM, the bit “1” is stronger than the noise level: more photons arrive on detector when a bit “1” is under the input laser beam and the digital PD can be saturated. Comparing the pulse width of a bit “1” with that of noise pulses, a wider pulse width of the data bit “1” can be measured. Accordingly, a subsequent digital signal processing of the digital output of the digital PD, such as digital low pass filtering, may be used to retrieve the PPM data pattern while removing signal components caused by noise.

The above digital readout with a single digital photodetector may be extended to digital readout with a digital photodetector array that has multiple digital photodetectors such as SPAD sensor array shown in FIG. 4D. Digital data readout with a digital photodetector array may be used to implement a spatial differential data readout to better match the detector sensing area to the spatial pattern in the reflected beam from the optical disk. In addition, such a digital photodetector array can also be used for optical sensing for the servo control.

In many optical disk drives, the reflected beam from an optical disk at the optical detector may not be a uniform beam spot and may have a pattern with a spatial variation such as a split, symmetric pattern due to interference of different reflection components caused by the features on the optical disk. For example, the split, symmetric pattern may have a symmetric axis along the track direction and assembles a baseball-like pattern in many optical disks. Detailed analysis on such detector patterns from optical disk is well documented in literature. See, e.g., Upton and Milster, “Detector patterns from optical disks,” Optical Engineering, Vol. 40(6), pages 1010-1044 (June, 2001). The spatial pattern of the reflected beam from the optical disk can be used to determine the relative position of the beam with respect to a particular track and hence may be used for detecting a deviation of the beam from the center of a track. In addition, the reflected beam can also be used to detect the focusing error at the optical disk.

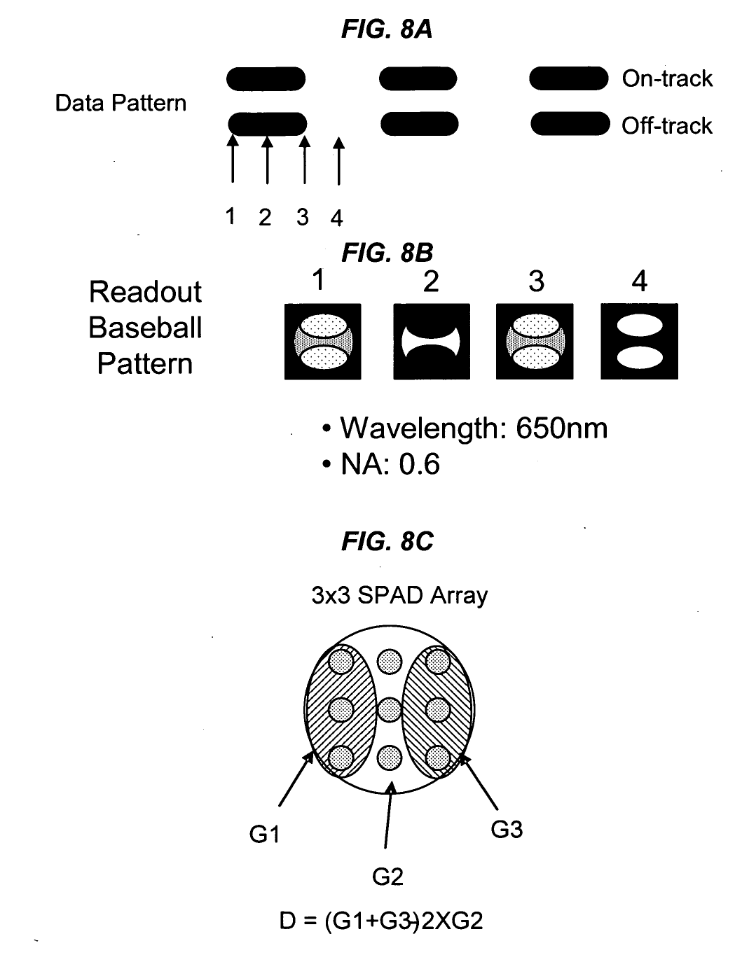

FIG. 8A illustrates an example of a data pattern on an optical disk by using an optical pickup unit with a numerical aperture (NA) of 0.6 and a laser at 650 nm. The reflected beam profile varies with the position of the beam relative to the on-track feature due to diffraction contributions from the on-track features, off-track features such as features in adjacent tracks, and other background features on the disk. FIG. 8B shows four reflected profiles from the optical disk for four different beam positions 1, 2, 3 and 4 along the track as indicated in FIG. 8B with a groove depth of one quarter of one wavelength of the light (d=λ/4). A single digital photodetector with a sensing area equal to or greater than the total area of the beam spot at the detector plane may be used to measure the total intensity of the entire beam for data readout. However, the optical sensing in optical disk drives is also used to provide measurements for proper beam focusing and proper position tracking of the beam on the disk and such measurements need position-sensitive sensing to measure the spatial profile of a beam. This usually requires spatially separated sensing areas within the beam spot at the detector surface for extracting servo information. Such servo information is used to control the tracking and focusing errors in directing the input beam to the optical disk for readout.

In one implementation, a digital photodetector array may be designed to have multiple digital photodetectors such as SPAD sensors that spread out as a 2-dimensional array within a footprint of the beam spot at the detection plane and may be used to separately measure the light intensity of different areas or positions within the beam spot. Such a digital photodetector array can be used to provide simultaneous measurements of both the data and the servo information from the optical disk with highly sensitive, direct digital readout without the analog processing and analog-to-digital conversion.

FIG. 8C shows an example of a digital photodetector array with 3×3 digital photodetectors. A baseball-like beam pattern is also shown to illustrate a situation where different digital photodetectors capture different areas of the beam.

For digital data readout, the outputs from different digital photodetectors may be added together to produce a sum signal and this sum signal is then processed to extract the data. Alternatively, differential data readout may be implemented to extract data from optical measurements in three different areas within the beam.

More specifically, the multiple digital photodetectors may be divided into three sensing areas along the track direction: a central area G2 along the track, a left-hand-side area G1 on the left side of the track and a right-hand-side area G3 on the right side of the track. FIG. 8C illustrates the three sensing areas on the 3×3 digital photodetector array. Within each sensing area, the digital outputs from the multiple digital photodetectors are summed to produce an area sum signal. Hence, three area sum signals are generated. The final digital data readout signal D is the difference defined as follows:
D=(G1+G3)−2×G2.
In general, the D may be expressed as D=(G₁+G₃)−M×G₂ where M is a positive integer and varies based on the array design. In comparison to the data readout based on the total sum of all digital photodetectors in the array, this differential data readout reduce the common background noise in the reflected beam and the DC offset and noise of the photodetectors. Therefore, this differential data readout further improves the detection sensitivity and reduces the readout error in the direct digital readout.

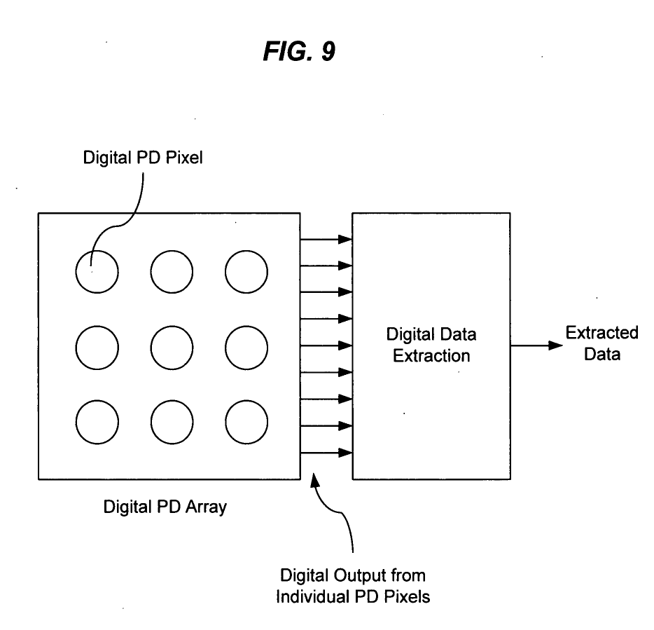

FIG. 9 shows a block diagram of the digital photodetector array with the digital data extraction circuitry in the subsequent digital processing. The digital data extraction circuitry is designed to produce the area sum signals G1, G2 and G3 and then generate the differential signal D.

The same individual digital outputs from the digital photodetectors in the same digital photodetector array can be digitally processed for the servo control. For the servo control, the 2-dimensional photodetectors are divided into four separate sensing quadrants A, B, C and D and the quadrant sum signals are used to produce the error indicators for the beam focusing and the beam tracking.

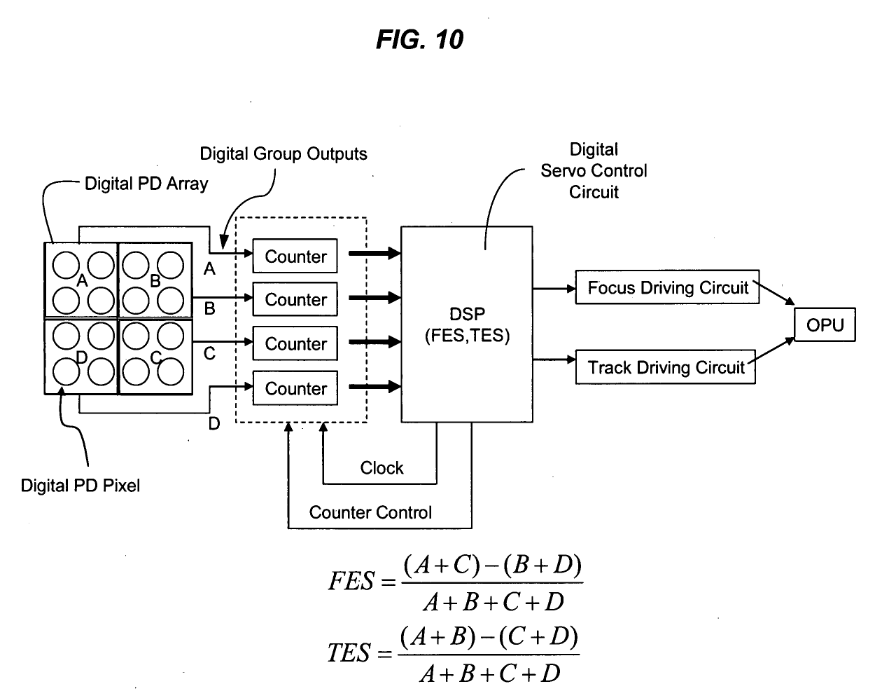

FIG. 10 illustrates a 2-dimensional digital photodetector array and its operation for the servo control. The 2-dimensional digital photodetector array may use any suitable digital photodetectors such as avalanche photodiodes. As an example, a 4×4 SPAD array based on the SPAD shown in FIG. 4A is illustrated in FIG. 10 for the servo control. This 4×4 SPAD array is divided into 4 groups in four quadrants A, B, C and D and every 2×2 array is a group. The output of each group is processed by a digital counter which counts the number of digital pulses from the digital photodetectors from each group. Hence, four digital group signals are generated. Next, a DSP circuit is used to produce the Focusing Error Signal (FES) and Tracking Error Signal (TES) based on a suitable servo algorithm. One example of the servo algorithm is to compute the FES and TES as follows:

$$FES = \frac{( A + C ) - ( B - D )}{A + B + C + D} , \\ TES = \frac{( A + B ) - ( C - D )}{A + B + C + D} ,$$

As illustrated, the DSP circuit may send a clock signal and a digital counter control signal back to the digital counters to control and synchronize the operations of the digital counters. The digital FES and TES are then converted into analog signals and a focusing driving analog circuit and a tracking driving analog circuit apply the final control signals to the optical pickup unit to adjust the beam position relative to the current track and the focusing of the beam at the optical disk. Hence, a close-loop servo control is realized.

The above servo control has a digital core where the reflected beam from the optical disk is directly converted into a digital signal by the digital photodetector array and the TES and FES are also digitally generated. Such digital processing of the servo control is flexible and robust in comparison with analog servo control designs used in many optical disk drives.

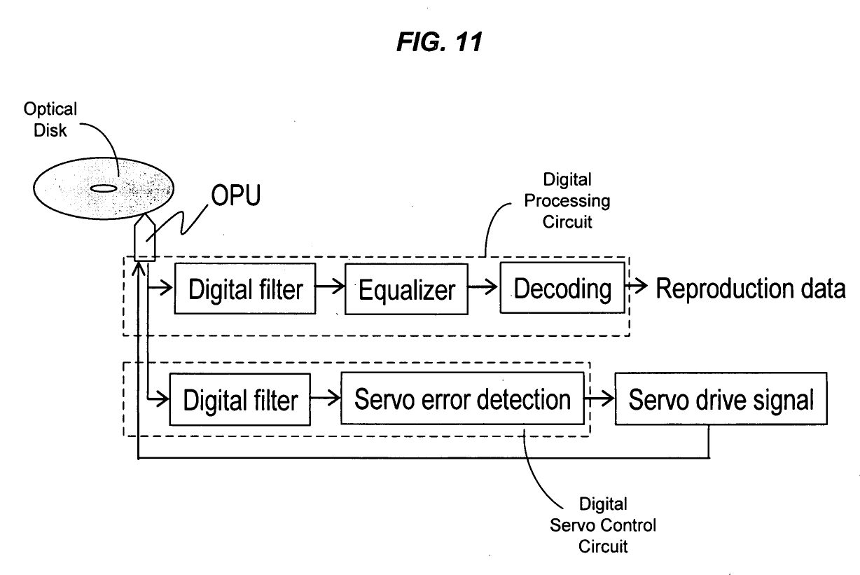

FIG. 11 illustrates an example of an optical disk drive that implements a digital photodetector array in the optical pickup unit, a digital processing circuit for data readout and a digital servo control circuit. An analog servo driver is used to generate the servo driving signals to the optical pickup unit from the digital FES and TES.

Notably, when a digital photodetector is used for readout of an optical disk drives, only the digital signal is involved in the signal detection and processing. Both digital photodiode and digital signal processing circuit can be fabricated by using standard CMOS processes. Hence, it is possible to integrate all of the circuitry into one chip to provide a System-on-Chip (SoC) design for the digital optical detection and digital processing. The use of the digital photodetector array allows for direct generation of the servo signals FES and TES in the digital domain via the digital counters and DSP circuit. Therefore, the digital circuit for processing digital outputs from the array to generate the digital FES and TES servo control signals can be integrated with either or both of the digital photodetector array and the digital data retrieval circuit on a single chip. In some implementations, the digital servo control circuit can be monolithically integrated on a single chip with either or both of the digital data processing circuit and the digital optical detector.

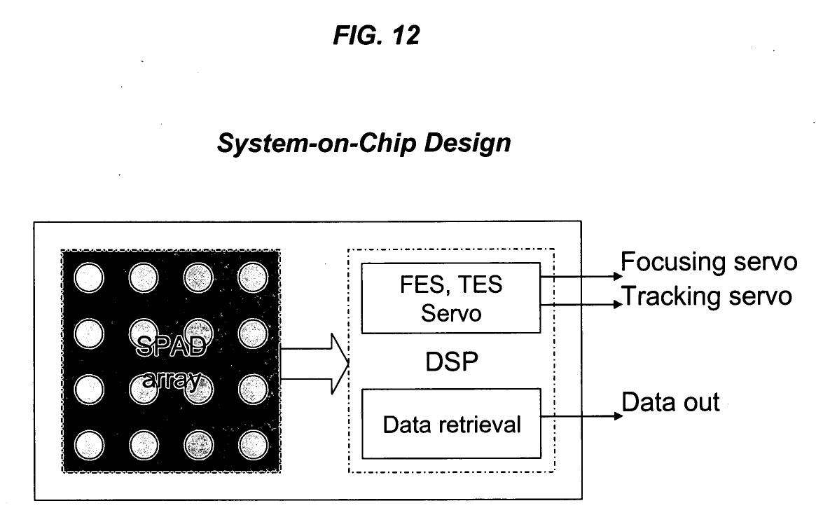

FIG. 12 shows one example of a system-on-chip design of the data readout and servo control for an optical disk drive where the digital photodetector array, the digital servo circuit and the digital data retrieval circuit are monolithically integrated on a single chip. The data pattern is generated from all pixels of the SPAD array by using either the total sum scheme or the differential readout scheme.

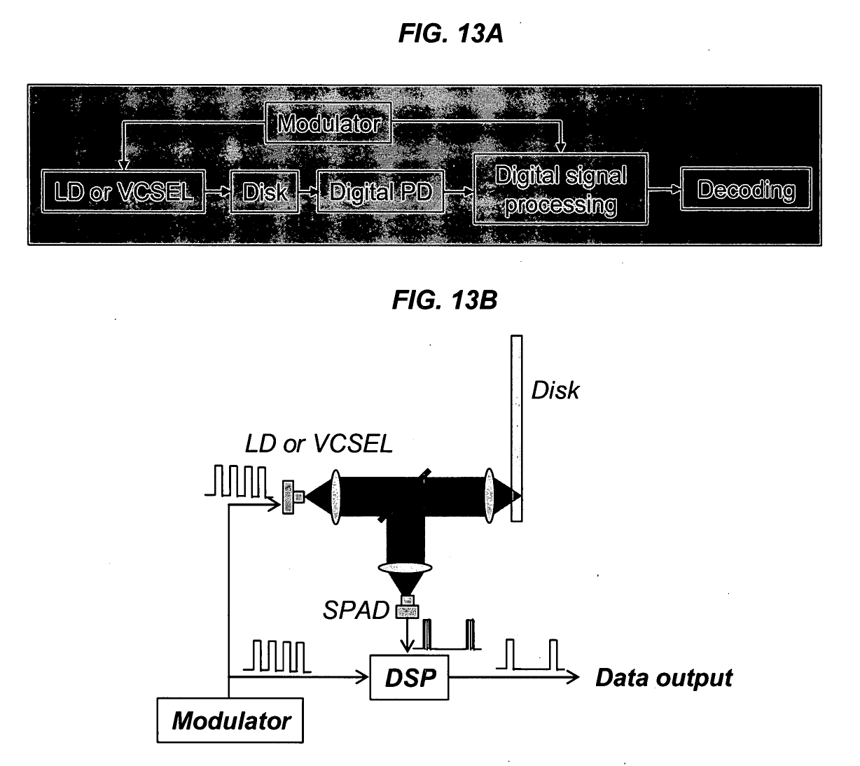

The above described optical disk drives based on digital optical detection and digital processing without analog processing may further implement a modulation mechanism that modulates the input laser beam to the optical disk for readout at a high modulation frequency. In this design, the digital sampling at the digital signal processing circuitry may be correlated with the same modulation frequency to further reduce noise and the bit error rate in the data readout. FIGS. 13A and 13B illustrate one example of such a disk drive. A high frequency modulator is used to supply a high-frequency modulation signal to the laser diode (e.g., VCSEL) and the laser output beam is modulated with the high frequency. This modulated beam is used to readout the channel data bits from the optical disk and is detected by the digital photodetector. After sampling, the digital data goes to DSP for signal processing.

The above designs and techniques for digital optical detection and digital processing may be applied to various optical storage systems including optical disk drives such as audio compact disk (CD) players, computer CD-ROM drives, DVD players, Blu-Ray DVD players and HD-DVD players, and others. For example, optical disk drives based on recording materials that record data bits in a volume by two-photon optical absorption developed by Call/Recall, Inc. may implement the present digital optical detection and digital processing to allow for low optical power to be used for the input laser beam to the optical disks. Such 2-photon recorded 3D optical storage disk drives may be used to achieve a high capacity of about 100 GB to 500 GB per disk and high data rates about 1 Gb/sec to 10 Gb/sec using inexpensive, easily manufactured, and long-lived polymer media.

Examples of 2-photon recorded 3D optical storage disk drives are described in U.S. Pat. No. 6,590,852 entitled “Massively-parallel writing and reading of information within the three-dimensional volume of an optical disk, particularly by use of a doubly-telecentric afocal imaging system,” and U.S. Patent Publication No. 20040257962 entitled “Optical storage with ultra high storage capacity,” which are incorporated by reference as part of the specification of this application.

While this specification contains many specifics, these should not be construed as limitations on the scope of an invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or a variation of a subcombination.

Only a few implementations are disclosed. However, it is understood that variations and enhancements may be made.

What is claimed is:

1. An optical data storage device, comprising:
an optical pickup unit operable to direct an input optical beam to an optical storage medium and receive a returned optical beam from the optical storage medium in response to the input optical beam;
an optical sensor comprising a digital photodetector positioned to receive the returned optical beam from the optical pickup unit and operable to directly convert received light into digital electronic pulses; and
a digital processing circuit coupled to directly receive the digital electronic pulses from the optical sensor and configured to digitally process the digital electronic pulses to extract information in the returned optical beam.

2. The device as in claim 1, wherein the digital photodetector is an avalanche photodiode.

3. The device as in claim 1, wherein the digital photodetector is a Geiger-mode avalanche photodiode that detects a single photon.

4. The device as in claim 3, wherein the avalanche photodiode has a recharging time smaller than a period of a signal component with the highest frequency in the returned optical beam.

5. The device as in claim 1, wherein the digital processing circuit includes a pulse position modulation (PPM) mechanism to process digital electronic pulses that represent data bits recorded according to a pulse position modulation (PPM) on the optical storage medium to extract data bits.

6. The device as in claim 1, further comprising a single chip on which the digital photodiode and the digital processing circuit are monolithically integrated.

7. The device as in claim 1, wherein the digital processing circuit comprises a digital filter operable to filter the digital electronic pulses and a digital decoder operable to decode the output from the digital filter.

8. The device as in claim 1, further comprising:
a semiconductor laser operable to produce the input optical beam; and
an electronic modulator operable to produce a modulation signal at a modulation frequency, wherein the modulation signal is applied to modulate the semiconductor laser at the modulation frequency;
wherein the digital processing circuit is configured to sample the digital electronic pulses at the modulation frequency in extracting the information in the returned optical beam.

9. The device as in claim 1, wherein the optical sensor further comprises at least another digital photodetector.

10. An optical data storage device, comprising:
an optical pickup unit operable to direct an input optical beam to an optical storage medium and receive a returned optical beam from the optical storage medium in response to the input optical beam;
an optical sensor comprising an array of digital photodetectors positioned to receive the returned optical beam from the optical pickup unit, the digital photodetectors operable to directly convert received light into a plurality of trains of digital electronic pulses without analog to digital conversion, respectively, wherein different trains of digital electronic pulses correspond to light received at different locations within the returned optical beam at the optical sensor;
a digital data processing circuit coupled to directly receive the digital electronic pulses from the optical sensor and configured to digitally process the digital electronic pulses to extract data in the returned optical beam; and
a digital servo control circuit operable to directly receive the digital electronic pulses from the optical sensor and configured to digitally process the trains of digital electronic pulses of the different digital photodetectors to produce a digital focusing error signal and a digital tracking error signal.

11. The device as in claim 10, wherein the digital data processing circuit comprises a summing mechanism to add pulses from different digital photodetectors to produce a sum digital signal and processes the sum digital signal in extracting the data in the returned optical beam.

12. The device as in claim 10, wherein the digital data processing circuit comprises:
a first mechanism operable to add pulses from different groups of digital photodetectors to produce different group sum signals for the different groups and to produce a differential output signal from the group sum signals to suppress a common noise in the different groups, and
a second mechanism operable to process the differential output signal in extracting the data in the returned optical beam.

13. The device as in claim 10, wherein the digital servo control circuit comprises:
a plurality of digital counters operable to receive the trains of digital electronic pulses of different digital photodetectors, respectively and to produce digital counter outputs corresponding to light received by four different areas on the optical sensor;
a mechanism operable to produce the digital focusing error signal and the digital tracking error signal from the digital counter outputs.

14. The device as in claim 10, further comprising an analog servo control driver circuit which is operable to control the optical pickup unit to correct a focusing error and a tracking error of the input optical beam at the optical storage in response to the digital focusing error and digital tracking error signals.

15. The device as in claim 10, wherein the digital servo control circuit is monolithically integrated with the digital data processing circuit on a single chip.

16. The device as in claim 10, wherein the digital servo control circuit is monolithically integrated with the array of digital photodetectors on a single chip.

17. The device as in claim 10, wherein the digital servo control circuit is monolithically integrated with the array of digital photodetectors and the digital data processing circuit on a single chip.

18. A method, comprising:
directly converting light reflected from an optical storage medium into electronic digital pulses without analog processing and analog to digital conversion; and
digitally processing the electronic digital pulses to obtain information carried in the light reflected from the optical storage medium.

19. The method as in claim 18, wherein the optical storage medium is an optical disk.

20. The method as in claim 18, wherein the optical storage medium is an audio compact disk (CD).

21. The method as in claim 18, wherein the optical storage medium is a computer CD-ROM.

22. The method as in claim 18, wherein the optical storage medium is a DVD.

23. The method as in claim 18, wherein the optical storage medium is a Blu-Ray DVD.

24. The method as in claim 18, wherein the optical storage medium is a HD-DVD.

25. The method as in claim 18, wherein the optical storage medium is an optical disk having a recording material that records data bits in a volume by two-photon optical absorption.

26. The method as in claim 18, further comprising:
encoding data bits on the optical storage medium with pit and land features where all pit features have an equal dimension to implement a pulse position modulation (PPM) data code; and
processing the electronic digital pulses to extract PPM data.

27. The method as in claim 18, further comprising:
using an array of digital photodetectors to directly convert the light reflected from the optical storage medium into the electronic digital pulses, where different digital photodetectors produce different trains of electronic digital pulses;
digitally summing different trains digital electronic pulses from different digital photodetectors to produce a sum digital signal; and
digitally processing the sum digital signal to extract data in the returned optical beam.

28. The method as in claim 18, further comprising:
using an array of digital photodetectors to directly convert the light reflected from the optical storage medium into the electronic digital pulses, where different digital photodetectors produce different trains of electronic digital pulses;
digitally adding pulses from different groups of digital photodetectors to produce different group sum signals for the different groups and to produce a differential output signal from the group sum signals to suppress a common noise in the different groups; and
digitally processing the differential output signal to extract data in the returned optical beam.

29. The method as in claim 18, further comprising:
using an array of digital photodetectors to directly convert the light reflected from the optical storage medium into the electronic digital pulses, where different digital photodetectors produce different trains of electronic digital pulses;
digitally counting a number of pulses in trains of digital electronic pulses from each group amongst four different groups of digital photodetectors in four quadrant areas in the array to produce a digital counter output;
digitally processing four digital counter outputs for the four quadrant areas in the array to produce a digital focusing error signal and a digital tracking error signal;
adjusting focusing of the light on the optical storage medium in response to the digital focusing error signal; and
adjusting a position of the light on the optical storage medium in response to the digital tracking error signal.

30. The method as in claim 18, further comprising:
modulating an input light beam incident to the optical storage medium at a modulation frequency; and
sampling the digital electronic pulses at the modulation frequency in extracting the information in the returned optical beam to suppress noise.

31. An optical storage device, comprising:
an optical storage medium having pit and land features to represent digital data bits, wherein all pit features have an equal dimension according to a pulse position modulation (PPM) data code.

32. The device as in claim 31, wherein the optical storage medium is an optical disk.
